(19) United States
(12) Patent Application Publication
(10) Pub. No.: US 2022/0413849 A1
(43) Pub. Date: Dec. 29, 2022

(54) PROVIDING ATOMICITY FOR COMPLEX OPERATIONS USING NEAR-MEMORY COMPUTING

(71) Applicant: ADVANCED MICRO DEVICES, INC., SANTA CLARA, CA (US)

(72) Inventor: NUWAN JAYASENA, SANTA CLARA, CA (US)

(73) Assignee: ADVANCED MICRO DEVICES, INC., SANTA CLARA, CA (US)

(21) Appl. No.: 17/360,949

(22) Filed: Jun. 28, 2021

(51) Int. Cl. G06F 9/30

(52) U.S. Cl. CPC G06F 9/3004

(57) ABSTRACT

Providing atomicity for complex operations using near-memory computing is disclosed. In an implementation, a complex atomic operation is decomposed into a set of sequential operations that is stored in a near-memory instruction store. A memory controller receives a request from a host execution engine to issue the complex atomic operation and initiates execution of the stored set of sequential operations on a near-memory compute unit. The complex atomic operation may be a user-defined complex atomic operation.

### BACKGROUND

Computing systems often include a number of processing resources (e.g., one or more processors), which can retrieve and execute instructions and store the results of the executed instructions to a suitable location. A processing resource (e.g., central processing unit (CPU) or graphics processing unit (GPU)) can comprise a number of functional units such as arithmetic logic unit (ALU) circuitry, floating point unit (FPU) circuitry, and/or a combinatorial logic block, for example, which can be used to execute instructions by performing arithmetic operations on data. For example, functional unit circuitry can be used to perform arithmetic operations such as addition, subtraction, multiplication, and/or division on operands. Typically, the processing resources (e.g., processor and/or associated functional unit circuitry) can be external to a memory device, and data is accessed via a bus or interconnect between the processing resources and the memory device to execute a set of instructions. To reduce the amount of accesses to fetch or store data in the memory device, computing systems can employ a cache hierarchy that temporarily stores recently accessed or modified data for use by a processing resource or a group of processing resources. However, processing performance can be further improved by offloading certain operations to a memory-based execution device in which processing resources are implemented internal and/or near to a memory, such that data processing is performed closer to the memory location storing the data rather than bringing the data closer to the processing resource. A near-memory or in-memory compute device can save time by reducing external communications (i.e., host to memory device communications) and can also conserve power.

### BRIEF DESCRIPTION OF THE DRAWINGS

FIG. 1 sets forth a block diagram of an example system for providing atomicity for complex operations using near-memory computing in accordance with some implementations of the present disclosure.

FIG. 2 sets forth a block diagram of another example system for providing atomicity for complex operations using near-memory computing in accordance with some implementations of the present disclosure.

FIG. 3 sets forth a block diagram of another example system for providing atomicity for complex operations using near-memory computing in accordance with some implementations of the present disclosure.

FIG. 4 sets forth a flow chart illustrating another example method of providing atomicity for complex operations using near-memory computing in accordance with some implementations of the present disclosure.

FIG. 5 sets forth a flow chart illustrating another example method of providing atomicity for complex operations using near-memory computing in accordance with some implementations of the present disclosure.

FIG. 6 sets forth a flow chart illustrating another example method of providing atomicity for complex operations using near-memory computing in accordance with some implementations of the present disclosure.

FIG. 7 sets forth a flow chart illustrating another example method of providing atomicity for complex operations using near-memory computing in accordance with some implementations of the present disclosure.

FIG. 8 sets forth a flow chart illustrating another example method of providing atomicity for complex operations using near-memory computing in accordance with some implementations of the present disclosure.

### DETAILED DESCRIPTION

Multiple threads updating the same memory location is a common motif in many applications domains (graph processing, machine learning recommendation systems, scientific simulations etc.), which often requires inter-thread synchronization. Irregular updates to in-memory data structures from multiple parallel threads require techniques to avoid incorrect results due to conflicting concurrent updates to the same data items. Software-based techniques can be used to ensure correctness for these updates, but such software-based solutions incur high overheads. In addition, support for atomic operations in hardware is typically limited to synchronization primitives (e.g., locks) and does not extend to the atomic application of user-defined or complex atomic operations on bulk data.

As mentioned above, software solutions can be used for providing correctness for concurrent updates. For example, software can be used to provide explicit synchronization between threads (e.g., acquiring locks). However, this incurs the overhead of synchronization operations themselves (e.g., acquiring and releasing locks), as well as over-synchronization as many data elements are typically guarded via a single synchronization variable in fine-grained data structures. Software can also be used to sort a stream of irregular updates by the indices of the data items they affect. Once sorted, multiple updates to the same data element are detected (as they are adjacent in the sorted list) and handled. However, this incurs the overhead of sorting the stream of updates, which is often a large amount of data in applications of interest. Software can also be used to perform redundant computation such that all updates to a given data element are performed by one thread (thereby avoiding the need to synchronize). However, this increases the number of computations and not all algorithms are amenable to this approach. Another technique that can be used to provide correctness is lock free data structures. These avoid the need for explicit synchronization but greatly increase software complexity, can be slower than their traditional counterparts aside from synchronization overheads, and are not applicable in all cases.

Furthermore, where simple atomic operations in memory (e.g., atomic-add) are made available, such operations lack the capability of complex, user-defined atomic operations that require a sequence of arithmetic operations to complete. For example, an atomic-add (or ‘fetch-and-add’) operation is limited to reading a value from a single location in memory, adding a single operand value to the read value, and storing the result to the same location in memory.

Implementations in accordance with the present disclosure are directed to providing atomicity for complex operations using near-memory computing. Implementations provide mechanisms that enable a memory controller to utilize near-memory or in-memory compute units to atomically execute user-defined complex operations to avoid the difficulty and overhead of explicit thread-level synchronization. Implementations further provide the flexibility of applying user-defined, complex atomic operations to bulk data without the overhead of software synchronization and other software techniques. Implementations further support user-programmability to enable arbitrary atomic operations. In particular, implementations address the need for atomicity in the context of fine-grain out-of-order schedulers such as memory controllers.

An implementation is directed to a method of providing atomicity for complex operations using near-memory computing that includes storing a set of sequential operations in a near-memory instruction store, wherein the sequential operations are component operations of a complex atomic operation. The method also includes receiving a request to issue the complex atomic operation. The method also includes initiating execution of the stored set of sequential operations on a near-memory compute unit. In some implementations, the method includes receiving a request to store the set of sequential operations corresponding to the complex atomic operation, wherein the complex atomic operation is a user-defined complex atomic operation. In some of these implementations, the request to store the set of sequential operations for the user-defined complex atomic operation is received via an application programming interface (API) call from host system software or a host application. In some cases, the set of sequential operations includes one or more arithmetic operations. In some implementations, a memory controller waits until all operations in the set of sequential operations have been initiated before scheduling another memory access.

In some implementations, storing a set of sequential operations in a near-memory instruction store, wherein the sequential operations are component operations of a complex atomic operation includes storing a plurality of sets of sequential operations respectively corresponding to a plurality of complex atomic operations and storing a table that maps a particular complex atomic operation to a location of a corresponding set of sequential operations in the near memory instruction store.

In some implementations, initiating execution of the stored set of sequential operations on a near-memory compute unit includes reading, by a memory controller, each operation in the set of sequential operations from the near-memory instruction store, wherein the near-memory instruction store is coupled to the memory controller. Such implementations further include issuing, by the memory controller, each operation to the near-memory compute unit.

In some implementations, initiating execution of the stored set of sequential operations on a near-memory compute unit includes issuing, by a memory controller to a memory device, a command to execute the set of sequential operations, wherein the near-memory instruction store is coupled to the memory device. In some of these implementations, the memory controller orchestrates the execution of the component operations on the near-memory compute unit through a series of triggers. In some implementations, the near-memory instruction store and the near-memory compute unit are closely coupled to a memory controller that interfaces with a memory device.

Another implementation is directed to a computing device for providing atomicity for complex operations using near-memory computing. The computing device is configured to store a set of sequential operations in a near-memory instruction store, wherein the sequential operations are component operations of a complex atomic operation. The computing device is also configured to receive a request to issue the complex atomic operation. The computing device is further configured to initiate execution of the stored set of sequential operations on a near-memory compute unit. In some implementations, the computing device is further configured to receive a request to store the set of sequential operations corresponding to the complex atomic operation, where the complex atomic operation is a user-defined complex atomic operation. In one example, the request to store the set of sequential operations for the user-defined complex atomic operation is received via an API call from host system software or a host application.

In some implementations, storing a set of sequential operations in a near-memory instruction store, wherein the sequential operations are component operations of a complex atomic operation includes storing a plurality of sets of sequential operations respectively corresponding to a plurality of complex atomic operations and storing a table that maps a particular complex atomic operation to a location of a corresponding set of sequential operations in the near memory instruction store.

In some implementations, initiating execution of the stored set of sequential operations on a near-memory compute unit includes reading, by a memory controller, each operation in the set of sequential operations from the near-memory instruction store, wherein the near-memory instruction store is coupled to the memory controller. Such implementations further include issuing, by the memory controller, each operation to the near-memory compute unit.

In some implementations, initiating execution of the stored set of sequential operations on a near-memory compute unit includes issuing, by a memory controller to a memory device, a command to execute the set of sequential operations, wherein the near-memory instruction store is coupled to the memory device. In some of these implementations, the memory controller orchestrates the execution of the component operations on the near-memory compute unit through a series of triggers. In some implementations, the near-memory instruction store and the near-memory compute unit are closely coupled to a memory controller that interfaces with a memory device.

Yet another implementation is directed to a system for providing atomicity for complex operations using near-memory computing. The system includes a memory device, a near-memory memory compute unit coupled to the memory device, and a near-memory instruction store that stores a set of sequential operations, where the sequential operations are component operations of a complex atomic operation. The system also includes a memory controller configured to receive a request to issue the complex atomic operation and initiate execution of the stored set of sequential operations on the near-memory compute unit.

In some implementations, where the near-memory instruction store is coupled to a memory controller, initiating execution of the stored set of sequential operations on the near-memory compute unit includes reading, by the memory controller, each operation in the set of sequential operations from the near-memory instruction store and issuing, by the memory controller, each operation to the near-memory compute unit.

In some implementations, wherein the near-memory instruction store is coupled to the memory device, initiating execution of the stored set of sequential operations on a near-memory compute unit includes issuing, by a memory controller to the memory device, a command to execute the set of sequential operations. In some of these implementations, the memory controller orchestrates the execution of the component operations on the near-memory compute unit through a series of triggers.

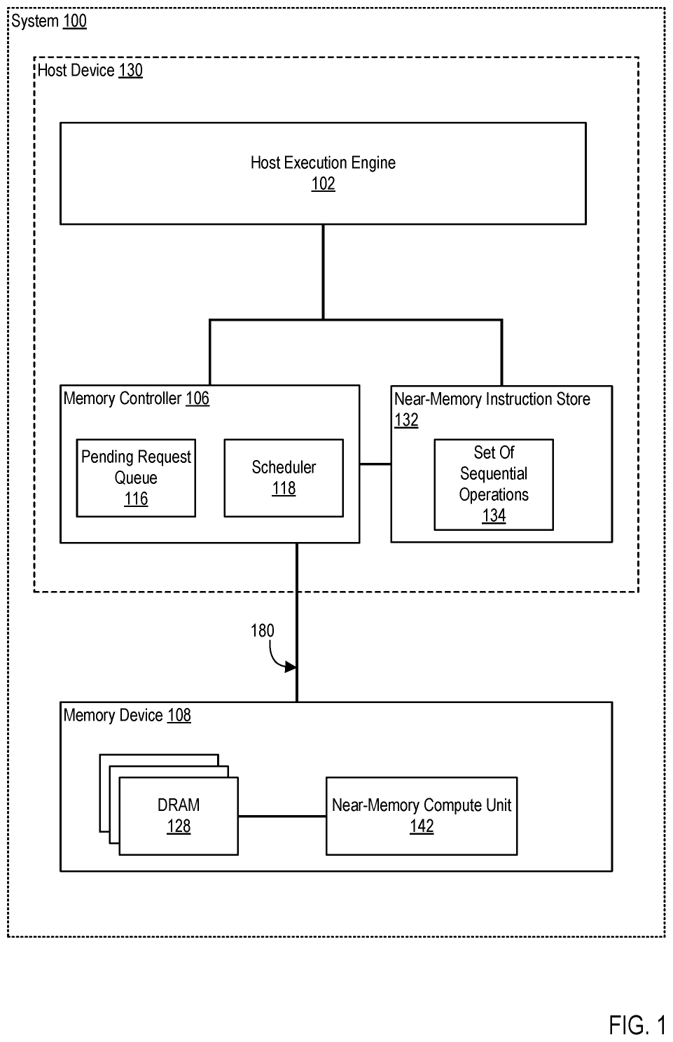

Implementations in accordance with the present disclosure will be described in further detail beginning with FIG. 1. Like reference numerals refer to like elements throughout the specification and drawings. FIG. 1 sets forth a block diagram of an example system 100 for providing atomicity for complex operations using near-memory computing in accordance with some implementations of the present disclosure. The example system 100 of FIG. 1 includes a host device 130 (e.g., a system-on-chip (SoC) device or system-in-package (SiP) device) that includes at least one host execution engine 102. Although not depicted, the host device 130 can include multiple host execution engines including multiple different types of host execution engines. In various examples, a host execution engine 102 is a central processing unit (CPU), a graphics processing unit (GPU), an accelerated processing unit (APU), an application-specific processor, a configurable processor, or other such compute engine capable of supporting multiple concurrent sequences of computation. In some implementations, a host compute engine includes multiple physical cores or other forms of independent execution units. The host device 130 hosts one or more applications on the host execution engine 102. The hosted applications are, for example, singled threaded applications or multithreaded applications, such that a host execution engine 102 executes multiple concurrent threads of an application or multiple concurrent applications and/or multiple execution engines 102 concurrently executes threads of the same application or multiple applications.

The system 100 also includes at least one memory controller 106 used by the host execution engines 102 to access a memory device 108 through a host-to-memory interface 180 (e.g., a bus or interconnect). In some examples, the memory controller 106 is shared by multiple host execution engines 102. While the example of FIG. 1 depicts a single memory controller 106 and a single memory device 108, the system 100 can include multiple memory controllers each corresponding to a memory channel of one or more memory devices. The memory controller 106 includes a pending request queue 116 for buffering memory requests received from the host execution engine 102 or other requestors in the system 100. For example, the pending request queue 116 holds memory requests received from multiple threads executing on one hosting execution engine or memory requests received from threads respectively executing on multiple host execution engines. While a single pending request queue 116 is shown, some implementations include multiple pending request queues. The memory controller 106 also includes a scheduler 118 that determines the order in which to service the memory requests pending in the pending request queue 116, and issues the memory requests to the memory device 108. Although depicted in FIG. 1 as being a component of the host device 130, the memory controller 106 can also be separate from the host device.

In some examples, the memory device 108 is a DRAM device to which the memory controller 106 issues memory requests. In various examples, the memory device 108 is a high bandwidth memory (HBM), a dual in-line memory module (DIMM), or a chip or die thereof. In the example of FIG. 1, the memory device 108 includes at least one DRAM bank 128 that services memory requests received from the memory controller 106.

In some implementations, the memory controller 106 is implemented on a die (e.g., an input/output die) and the host execution engine 102 is implemented on one or more different dies. For example, the host execution engine 102 can be implemented by multiple dies each corresponding to a processor core (e.g., a CPU core or a GPU core) or other independent processing unit. In some examples, the memory controller 106 and the host device 130 including the host execution engine 102 are implemented on the same chip (e.g., in SoC architecture). In some examples, the memory device 108, the memory controller 106, and the host device 130 including one or more host execution engines 102 are implemented on the same chip (e.g., in a SoC architecture). In some examples, the memory device 108, the memory controller 106, and the host device 130 including the host execution engines 102 are implemented in the same package (e.g., in an SiP architecture).

The example system 100 also includes a near-memory instruction store 132 closely coupled to and interfaced with the memory controller 106 (i.e., on the host side of the host-to-memory interface 180). In some examples, the near-memory instruction store 132 is a buffer or other storage device that is located on the same die or the same chip as the memory controller 106. The near-memory instruction store 132 is configured to store a set of sequential operations 134 corresponding to a complex atomic operation. That is, the set of sequential operations 134 are component operations of a complex atomic operation. The set of sequential operations 134 (i.e., memory operations such as loads and stores as well as computation operations), when performed in sequence, complete the complex atomic operation. In this context, the complex atomic operation is an operation completed without intervening accesses to the same memory location(s) accessed by the complex atomic operation. In some examples, the near-memory instruction store 132 stores multiple different sets of sequential operations corresponding to multiple complex atomic operations. In some implementations, a particular set of sequential operations corresponding to a particular complex atomic operation is identified by the memory location (e.g., address) in the near-memory instruction store 132 of the initial operation of the set of sequential operations.

When received by the memory controller 106, a request for a complex atomic operation is stored in the pending request queue 116 and subsequently selected by the scheduler 118 for servicing per a scheduling policy implemented by the memory controller 106. The request for a complex atomic operation can include operands such as host execution engine register values or memory addresses. Once the complex atomic operation is scheduled for servicing, the corresponding set of sequential operations 134 is read from the near-memory instruction store 132 and orchestrated to completion by the memory controller 106 before selecting any other operations from the pending request queue for servicing (i.e., preserving atomicity). When issuing the component operations, the memory controller inserts the values of operands in the component operation based on the operands supplied in the complex atomic operation request.

When the near-memory instruction store 132 stores multiple sets of sequential operations corresponding to multiple complex atomic operations, complex atomic operation requests sent to the memory controller 106 include an indication of the complex atomic operation to which the request corresponds. In some examples, each complex atomic operation has a unique opcode that can be used as a complex atomic operation identifier for the set of sequential operations 134 corresponding to that complex atomic operation. In other examples, one opcode is used to indicate that a request is a complex atomic operation request while a complex atomic operation identifier is passed as an argument with the request to identify the particular complex atomic operation and corresponding set of sequential operations. In one example, a lookup table maps complex atomic operation identifier to a memory location in the near-memory instruction store 132 that contains the first operation of the set of sequential operations.

In some examples, the complex atomic operation is a user-defined atomic operation. For example, the user-defined complex atomic operation is decomposed into its component operations by a developer (e.g., by writing a custom code sequence) or by a software tool (e.g., a compiler or assembler) based on a representation of the atomic operation provided by an application developer. The near-memory instruction store 132 is initialized with the set of sequential operations 134 by the host execution engine 102, for example, at system startup, application startup, or application runtime. In some examples, storing the set of sequential operations 134 is performed by a system software component. In one example, this system software allocates a region of the near-memory instruction store 132 to an application at the start of that application and application code carries out the storing the set of sequential operations 134 in the near-memory instruction store 132. The specific operation of writing the set of sequential operations 134 for a complex atomic operation into the near-memory instruction store can be achieved via memory-mapped writes or via a specific application programming interface (API) call. Accordingly, the host execution engine 102 interfaces with the near-memory instruction store 132 to provide the set of sequential operations 134. However, the near-memory instruction store 132 is distinguished from other caches and buffers utilized by the host execution engine 102 in that the near-memory instruction store 132 is not a component of a host execution engine 102. Rather, the near-memory instruction store 132 is closely associated with the memory controller (i.e., on the memory controller side of an interface between the host execution engine 102 and the memory controller 106).

In the example system 100 of FIG. 1, the memory device 108 includes a near-memory compute unit 142. In some examples, the near-memory compute unit 142 includes an arithmetic logic unit (ALU), registers, control logic, and other components to execute basic arithmetic operations and carry out load and store instructions. In some cases, the near-memory compute unit 142 is a processing-in-memory (PIM) unit that is a component of the memory device 108. Although not depicted, the near-memory compute unit 142 can be implemented within the DRAM bank 128 or in a memory logic die coupled to one or more memory core dies. In other examples, although not depicted, the near-memory compute unit 142 is a processing unit, such as an application specific processor or configurable processor, that is separate from but closely coupled to the memory device 108.

When the memory controller 106 schedules the complex atomic operation for issuance to the memory device 108, the memory controller reads the set of sequential operations 134 from the near-memory instruction store 132 and issues the operations as commands to the near-memory compute unit 142. The near-memory compute unit 142 receives the commands for the operations in the set of sequential operations 134 from the memory controller 106 and executes the complex atomic operation. That is, the near-memory compute unit 142 executes each operation (e.g., load, store, add, multiply) in the set of sequential operations 134 on the targeted memory location(s) without any intervening access by operations not included in the set of sequential operations 134.

When a memory request is received by the memory controller 106, the memory controller 106 determines whether the memory request is a complex atomic operation request. For example, a special opcode or command indicates that the memory request is a complex atomic operation request. If the request is for a complex atomic operation, the set of sequential operations 134 are fetched from the near-memory instruction store 132 and issued to near-memory compute unit 142 for execution. The starting point for the component operations in the near-memory instruction store 132 is indicated directly (e.g., by a location in the near-memory instruction store 132) or indirectly (e.g., via a table lookup of a complex atomic operation identifier included) in the complex atomic operation request received by the memory controller 106. The completion of the complex atomic operation is indicated either via a number of component operations encoded in the atomic operation request, a marker embedded in the instruction stream stored in the near-memory instruction store 132, by an acknowledgment from the near-memory compute unit 142, or by another suitable technique. For example, the number of component operations can be included in the lookup table that identifies the starting point of the set of sequential operations 134.

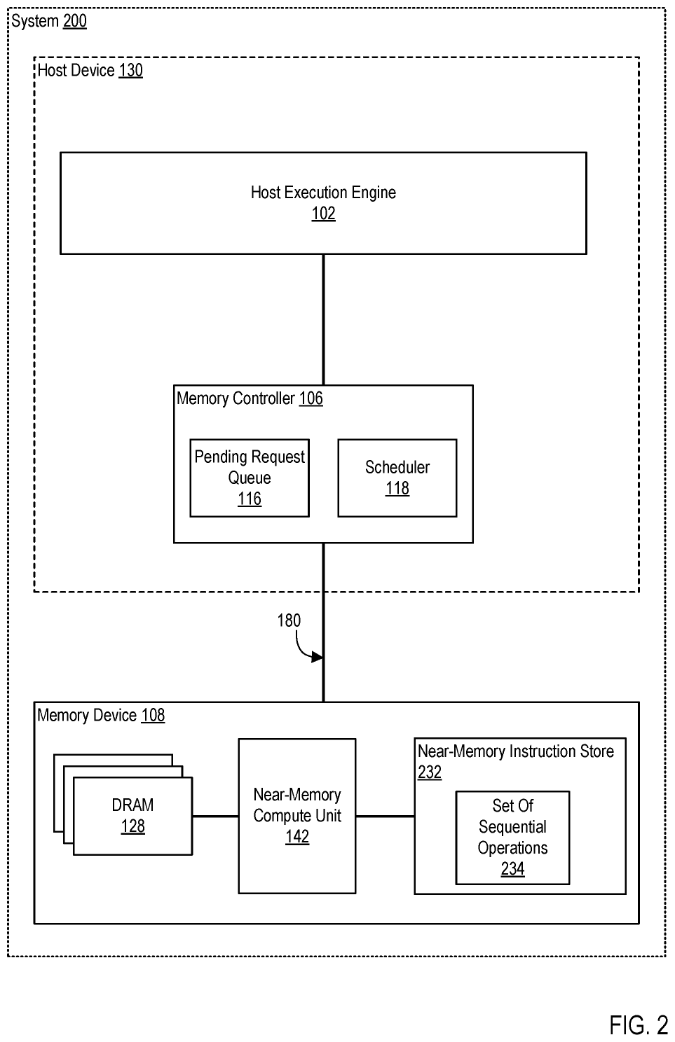

For further explanation FIG. 2 sets forth a block diagram of an alternative example system 200 for providing atomicity for complex operations using near-memory computing in accordance with some implementations of the present disclosure. The example system 200 is similar to the example system 100 of FIG. 1 except that the near-memory instruction store 232 is closely coupled to the memory device 108 (i.e., on the memory side of the host-to-memory interface 180) instead of the memory controller 106. In some examples, as shown in FIG. 2, the near-memory instruction store 232 is a component of the memory device 108. In these examples, the near-memory instruction store 232 is a buffer or other independent storage component of the memory device or may be a portion of the DRAM storage (e.g., DRAM bank 128) allocated for use as the near-memory instruction store 232. In other examples, the near-memory instruction store 232 is external but closely coupled to the memory device 108. The set of sequential operations 234 is stored in the near-memory instruction storage 232 by the host execution engine 102 through the memory controller 106, as described above, at system or application startup or at application runtime.

In the example of FIG. 2, the memory controller 106 need not read the set of sequential operations 234 from the near-memory instruction store 232 in response to receiving a complex atomic operation request. Rather, the memory controller 106 can initiate execution of the set of sequential operations 234 on the near-memory compute unit 142. In some implementations, the memory controller 106 issues a single command to the memory device 108 indicating the issue of a complex atomic operation, such that the near-memory compute unit 142 reads the set of sequential operations from the near-memory instruction store 232. In such cases, the complex atomic operation request received by the memory controller 106 directly or indirectly (e.g., via a table lookup of the complex atomic operation identifier) includes an indication of the duration (e.g., in clock cycles) of the set of sequential operations 234 or the number of component-operations to be executed for the complex atomic operation. This information is used by the memory controller 106 to determine when a subsequent command can be sent to the memory device 108 while ensuring atomicity. In other implementations, the complex atomic operation request includes a sequence of triggers the memory controller 106 must send to the memory device 108 to orchestrate the component operations of the complex atomic operation. In one such implementation, the triggers include a sequence of load and store operations (or variants thereof) that will be interpreted by the memory device 108 to orchestrate the sequential operations stored in the near-memory instruction store 232 associated with it. An example of such an implementation is a bit vector or array received by the memory controller 106 as part of the complex atomic operation request that indicates loads via a specific value and stores via an alternate specific value. These loads and stores can be issued by the host execution engine 102 with one or more memory addresses associated with the complex atomic operation (the simplest case being all such operations being issued with a single address sent to the memory controller 106 as part of the complex atomic operation request). All such triggers associated with the complex atomic operation are sent to the memory device 108 before any other pending requests are serviced by the memory controller to ensure atomicity.

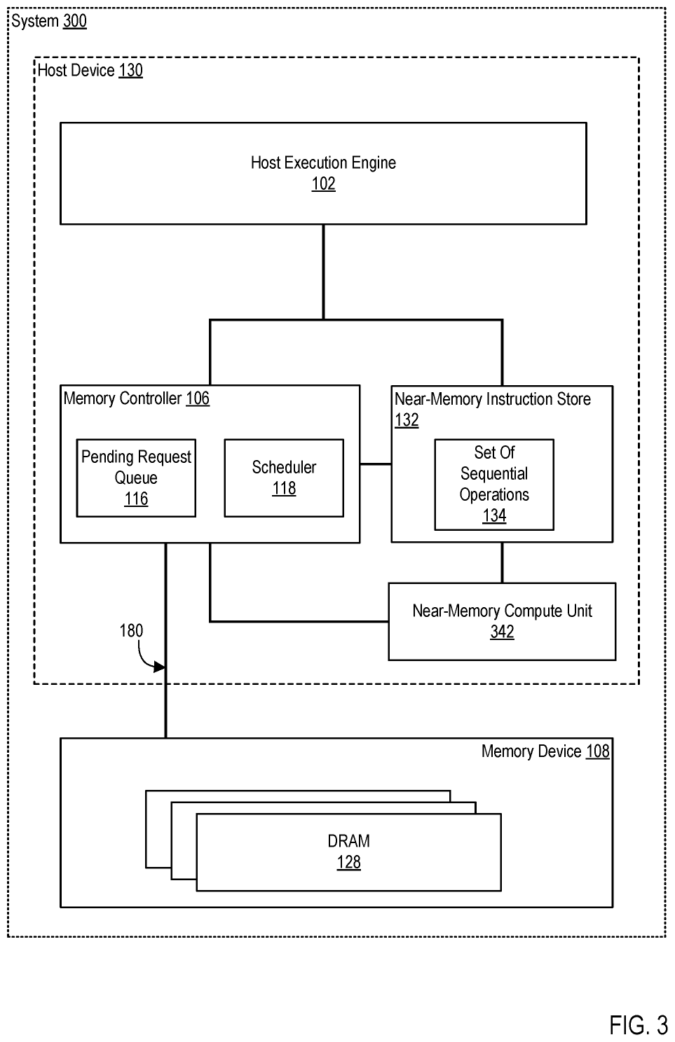

For further explanation FIG. 3 sets forth a block diagram of an alternative example system 300 for providing atomicity for complex operations using near-memory computing in accordance with some implementations of the present disclosure. The example system 300 is similar to the example system 100 of FIG. 1 except that a near-memory compute unit 342 is closely coupled to the memory controller 106 (i.e., on the host side of the host-to-memory interface 180) instead of the memory device 108. In some implementations of the example system 300 of FIG. 3, the memory controller 106 reads the operations in the set of sequential operations 134 from the near-memory instruction store 132 in response to receiving a request for a complex atomic operation and issues each component operation to the near-memory compute unit 342, as described above with reference to the example system 100 of FIG. 1. In other implementations, the memory controller 106 issues a single command to the near-memory compute unit 342 that prompts the near-memory compute unit 342 to read the operations in the set of sequential operations 134 from the near-memory instruction store 132. For example, the command can include a complex atomic operation identifier or a location in the near-memory instruction store 132. In this example system, the execution of the set of sequential operations 134 initiates reads and writes from the memory device 108 over the host-to-memory interface 180 for accessing memory data necessary for the complex atomic operation. In some examples, the command also indicates the number of operations or a marker is included in the set of sequential operations 134 to indicate the end of the sequence. In some implementations, the near-memory compute unit 342 signals to the memory controller 106 that the set of sequential operations 134 has completed such that the memory controller 106 can proceed to service the next request in the pending request queue 116 while preserving atomicity. In these examples, because the near-memory compute unit 342 is located on the host side of the host-to-memory interface, such signaling does not create additional traffic on the memory interface.

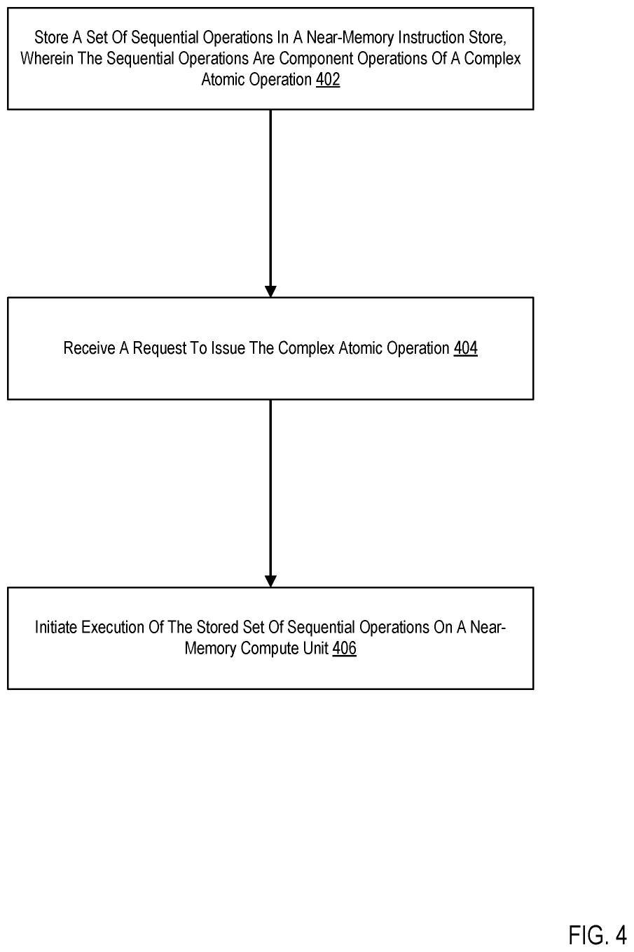

For further explanation, FIG. 4 sets forth a flow chart illustrating an example method of providing atomicity for complex operations using near-memory computing in accordance with some implementations of the present disclosure. The method includes storing 402 a set of sequential operations in a near-memory instruction store, wherein the sequential operations are component operations of a complex atomic operation. In some examples, a complex atomic operation is a set of sequential operations targeting one or more memory locations that must be completed without intervening access to those one or more memory locations. In some examples, storing 402 a set of sequential operations in a near-memory instruction store is carried out by storing such component operations corresponding to a complex atomic operation in a near-memory instruction store such as, for example, the near-memory instruction store 132 of FIG. 1 and FIG. 3 or the near-memory instruction store 232 of FIG. 3. In some implementations, storing 402 a set of sequential operations in a near-memory instruction store is carried out by a host execution engine (e.g., the host execution engine 102 of FIGS. 1-3) writing the operations of the set of sequential operations to the near-memory instruction store. In other implementations, storing 402 a set of sequential operations in a near-memory instruction store is carried out by a memory controller (e.g., the memory controller 106 of FIGS. 1-3) writing the operation of the set of sequential operations to the near-memory instruction store.

A complex atomic operation includes a series of component operations that are executed without intervening modification of data stored at memory locations accessed by the complex atomic operation. For example, a first thread executing a complex atomic operation on data at a particular memory location is guaranteed that no other thread will access that memory location before the complex atomic operation completes. To provide complex atomic operations that are not hardware-specific (i.e., specific to a near-memory compute implementation, memory vendor, etc.) and to provide user-defined complex atomic operations, component operations of the complex atomic operation are stored in the near-memory instruction store). This allows the processor to dispatch a single instruction for a complex atomic operation, which can include more component operations than simple atomic operations such as ‘fetch-and-add.’ Consider a non-limiting example of a user-defined complex operation that is a ‘fetch-fetch-add-and-multiply’ atomic operation that takes two memory locations and a scalar value as arguments. In this example complex atomic operation, a first value is loaded from a first memory location and a second value is loaded from a second memory location, the second value is added to the first value, this result is multiplied by the scalar value, and the final result is written to the first memory location. Written in pseudocode, the example complex atomic operation FetchFetchAddMult (mem_location1, mem_location2, value1) could include the following sequence of component operations:
load reg1, [mem_location1]//load the value at mem_location1 into reg1
load reg2, [mem_location2]//load the value at mem_location2 into reg2
add reg1, reg1, reg2//add the values in reg1 and reg2 and store the result in reg1
mult reg1, reg1, value1//multiply the value in reg1 by value1 and store the result in reg1
store mem_location1, reg1//store the value in reg1 at mem_location1
   The complex atomic operation is performed and the result is stored without intervening access to mem_location1 and mem_location2 by other threads. The memory controller will not dispatch other queued memory requests until all of the component operations of the complex atomic operation have been dispatched.

The example method of FIG. 4 also includes receiving 404 a request to issue the complex atomic operation. In some examples, receiving 404 a request to issue the complex atomic operation is carried out by a memory controller (e.g., e.g., the memory controller 106 of FIGS. 1-3) receiving a memory request that includes a request for a complex atomic operation. For example, the memory request is received from a host execution engine (e.g., the host execution engine 102 of FIGS. 1-3). In some implementations, the request for a complex atomic operation is indicated by a special instruction or opcode, or by a flag or argument, in the request. In some implementations, receiving 404 a request to issue the complex atomic operation includes determining that the request is a complex atomic operation request based on a special instruction, opcode, flag, argument, or metadata in the request. In some examples, the metadata for the request indicates how many component operations are included in the set of sequential operations or the duration of time required to complete the complex atomic operation. In some implementations, receiving 404 a request to issue the complex atomic operation also includes inserting the request into a pending request queue (e.g., the pending request queue 116 of FIGS. 1-3) along with other memory requests including memory requests that are not complex atomic operation requests.

The example method of FIG. 4 also includes initiating 406 execution of the stored set of sequential operations on a near-memory compute unit. In some examples, initiating 406 execution of the stored set of sequential operations on a near-memory compute unit is carried out by a scheduler (e.g., the scheduler 118 of FIGS. 1-3) of the memory controller (e.g., the memory controller 106 of FIGS. 1-3) scheduling the complex atomic operation request for issuance to a near-memory compute unit (e.g., the near-memory compute unit 142 of FIGS. 1 and 2 or the near-memory compute unit 342 of FIG. 3). In some implementations, initiating 406 execution of the stored set of sequential operations on a near-memory compute unit includes reading the set of sequential operations corresponding to the complex atomic operation from the near-memory instruction store and issuing each operation to the near-memory compute unit for execution, as will be explained in greater detail below. In other implementations, initiating 406 execution of the stored set of sequential operations on a near-memory compute unit includes sending a command to the near-memory compute unit to read the set of sequential operations from the near-memory instruction store and execute the instructions, as will be explained in greater detail below.

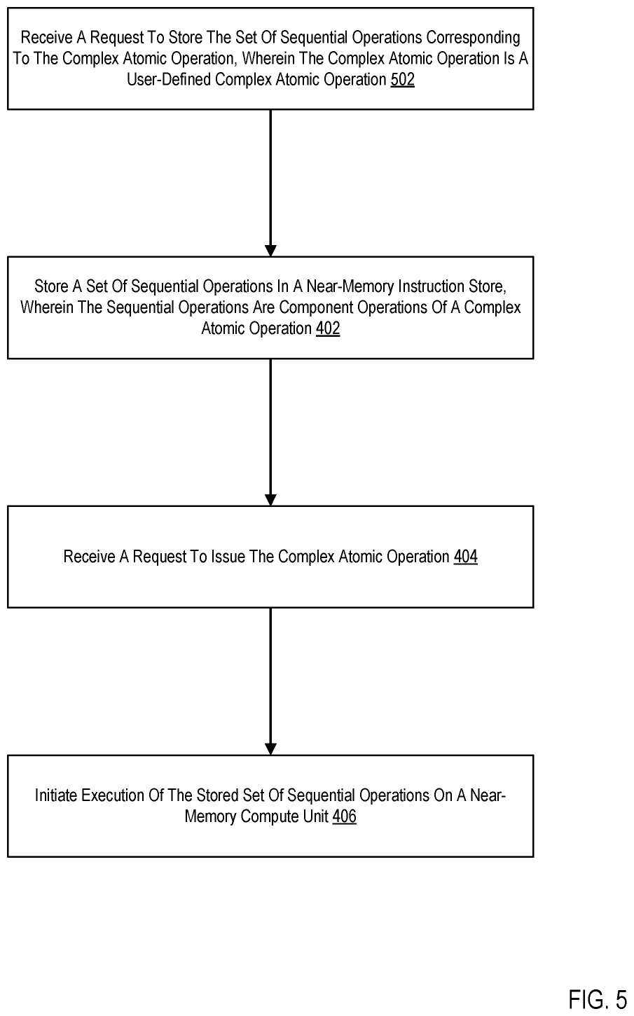

For further explanation, FIG. 5 sets forth a flow chart illustrating another example method of providing atomicity for complex operations using near-memory computing in accordance with some implementations of the present disclosure. Like the example of FIG. 4, the example method of FIG. 5 includes storing 402 a set of sequential operations in a near-memory instruction store, wherein the sequential operations are component operations of a complex atomic operation; receiving 404 a request to issue the complex atomic operation; and initiating 406 execution of the stored set of sequential operations on a near-memory compute unit.

The example method of FIG. 5 also includes receiving 502 a request to store the set of sequential operations corresponding to the complex atomic operation, wherein the complex atomic operation is a user-defined complex atomic operation. In some examples, receiving 502 a request to store the set of sequential operations corresponding to the complex atomic operation, wherein the complex atomic operation is a user-defined complex atomic operation, is carried out by the host execution engine (e.g., the host execution engine 102 of FIGS. 1-3) executing instructions representing a request to store a set of sequential operations that have been decomposed from a user-defined complex atomic operation. In various examples, the decomposition of the user-defined complex atomic operation into component operations is performed by a developer (e.g., by writing a custom code sequence), by a software tool (e.g., a compiler or assembler) based on a representation of the complex atomic operation provided by an application developer, or through some other annotation of source code. The request to store the set of sequential operations is received at system start-up time, application start-up time, or during application runtime. In some examples, the request to store the set of sequential operations is issued by a system software component. In some examples, the system software allocates a region of the near-memory instruction store to an application at the start of that application and the request to store the set of sequential operations to that region of the near-memory instruction store are issued by user application code. In various implementations, the specific request to write component operations in the near-memory instruction store is achieved via memory-mapped writes or via a specific API call.

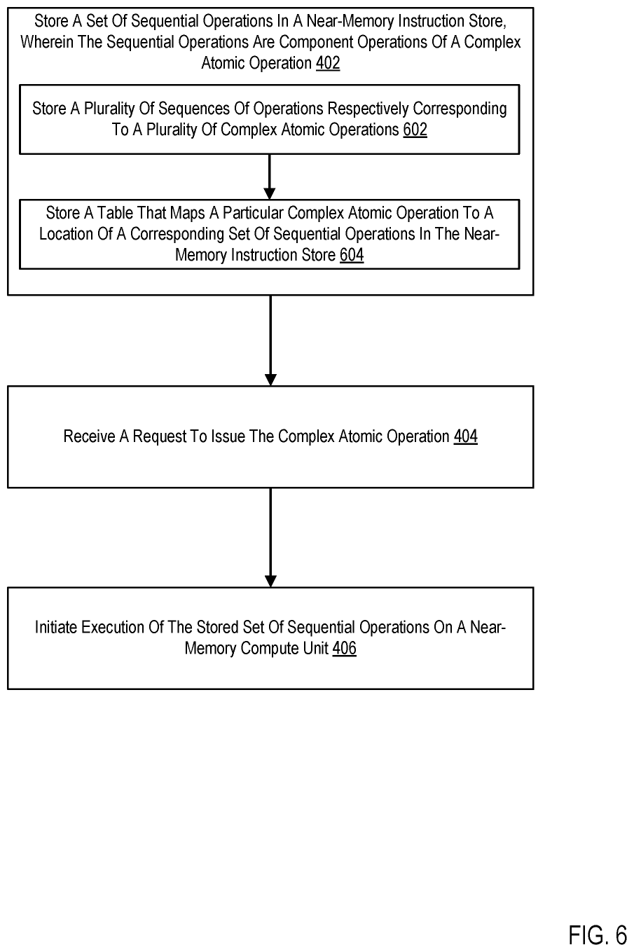

For further explanation, FIG. 6 sets forth a flow chart illustrating another example method of providing atomicity for complex operations using near-memory computing in accordance with some implementations of the present disclosure. Like the example of FIG. 4, the example method of FIG. 6 includes storing 402 a set of sequential operations in a near-memory instruction store, wherein the sequential operations are component operations of a complex atomic operation; receiving 404 a request to issue the complex atomic operation; and initiating 406 execution of the stored set of sequential operations on a near-memory compute unit.

In the example method of FIG. 6, storing 402 a set of sequential operations in a near-memory instruction store, wherein the sequential operations are component operations of a complex atomic operation, includes storing 602 a plurality of sets of sequential operations respectively corresponding to a plurality of complex atomic operations. In some examples, storing 602 a plurality of sets of sequential operations respectively corresponding to a plurality of complex atomic operations is carried out by storing a particular set of sequential operations, for a particular complex atomic operation, contiguously in one memory region of the near-memory instructions storage, storing another particular set of sequential operations, for a different complex atomic operation, contiguously in another memory region of the near-memory instructions storage, and so on. For example, a set of sequential operations of a complex atomic operation can be identified by the memory location (e.g., address, line, offset, etc.) of the first operation in the set of sequential operations. Consider an example where complex atomic operation 1 occupies lines 0-15 of the near-memory instruction store, complex atomic operation 2 occupies lines 16-31 of the near-memory instruction store, and so on. In such an example, complex atomic operation 1 can be identified by line 0 and complex atomic operation 2 can be identified by line 16. In some examples, markers are used to indicate the end of sequence. Using the above example, lines 15 and 31 can be null lines that indicate the end of a sequence in the set of sequential operations.

In the example method of FIG. 6, storing 402 a set of sequential operations in a near-memory instruction store, wherein the sequential operations are component operations of a complex atomic operation, also includes storing 604 a table that maps a particular complex atomic operation to a location of a corresponding set of sequential operations in the near-memory instruction store. In some examples, storing 604 a table that maps a particular complex atomic operation to a location of a corresponding set of sequential operations in the near-memory instruction store is carried out by implementing a lookup table that maps a complex atomic operation identifier to a particular location in the near-memory instruction store that identifies the corresponding set of sequential operations. Using the above example, the lookup table could map complex atomic operation 2 to line 16 of the near-memory instruction store. In some implementations, the lookup table indicates how many component operations are included in the sequence or a duration required to complete the set of sequential operations once they begin issuing to the near-memory compute unit.

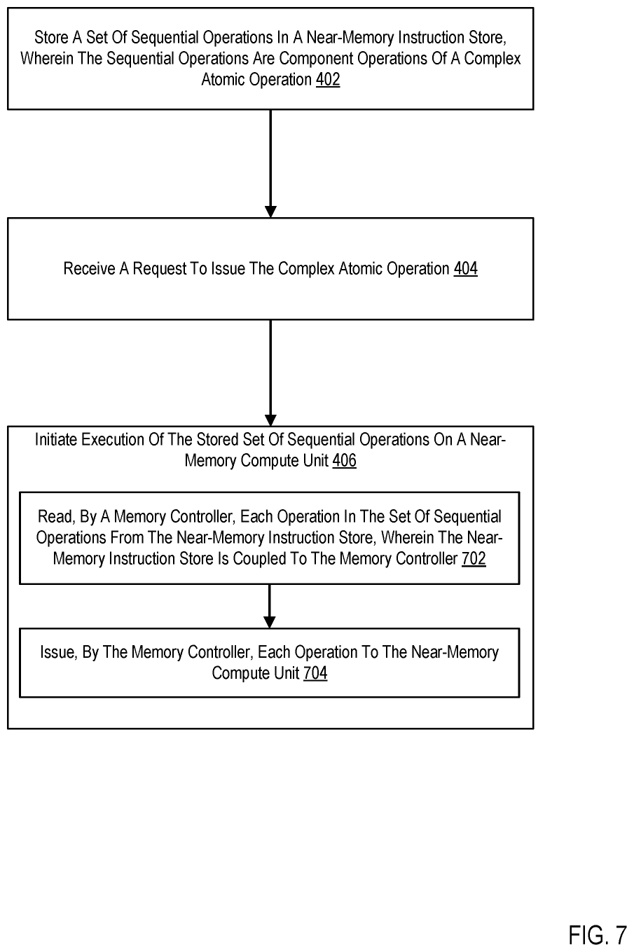

For further explanation, FIG. 7 sets forth a flow chart illustrating another example method of providing atomicity for complex operations using near-memory computing in accordance with some implementations of the present disclosure. Like the example of FIG. 4, the example method of FIG. 7 includes storing 402 a set of sequential operations in a near-memory instruction store, wherein the sequential operations are component operations of a complex atomic operation; receiving 404 a request to issue the complex atomic operation; and initiating 406 execution of the stored set of sequential operations on a near-memory compute unit.

In the example of FIG. 7, initiating 406 execution of the stored set of sequential operations on a near-memory compute unit includes reading 702, by the memory controller, each operation in the set of sequential operations from the near-memory instruction store, wherein the near-memory instruction store is coupled to a memory controller. In the example of FIG. 7, the near-memory instruction store (e.g., the near-memory instruction store 132 of FIG. 1 and FIG. 3) is coupled to the memory controller (e.g., the memory controller 106 of FIG. 1 and FIG. 3) in that the near-memory instruction store is implemented on the memory controller side of a host-to-memory interface (e.g., the host-to-memory interface 180 of FIG. 1-3). In some examples, reading 702, by the memory controller, each operation in the set of sequential operations from the near-memory instruction store, wherein the near-memory instruction store is coupled to a memory controller is carried out by identifying the initial operation in the set of sequential operations stored in the near-memory instruction store. In implementations where the near-memory instruction store includes multiple sets of sequential operations corresponding to multiple complex atomic operations, reading 702, by the memory controller, each operation in the set of sequential operations from the near-memory instruction store includes identifying a complex atomic operation identifier and determining the location of the initial operation in the set of sequential operations from a table that maps complex atomic operation identifiers to memory locations in the near-memory instructions store.

Once the initial operation in the set of sequential operations has been identified and issued to the near-memory compute unit or to the memory device that includes the near-memory compute unit, the next operation in the set of sequential operations is identified by incrementing the location by some value (e.g., line number, offset, address range). A counter can be utilized by the memory controller to iteratively determine the location of each operation in the sequence. In some examples, reading 702, by the memory controller, each operation in the set of sequential operations from the near-memory instruction store also includes determining the number of operations in the set of sequential operations from a table that maps complex atomic operation identifiers to the number of operations included in the set of sequential operations corresponding to the complex atomic operations. In some implementations, a marker in the set of sequential operations indicates the end of the sequence.

In the example of FIG. 7, initiating 406 execution of the stored set of sequential operations on a near-memory compute unit also includes issuing 704, by the memory controller, each operation to the near-memory compute unit. In some examples, issuing 704, by the memory controller, each operation to the near-memory compute unit includes inserting one or more operands into one or more operations in the set of sequential operations read from the near-memory instruction store. For example, a complex atomic operation request can include operand values, such as memory addresses or register values computed by the host execution engine. In this example, those values are inserted as operands of a component operation read from the near-memory instruction store. In some implementations, the complex atomic operation request includes a vector or array of operands that may be mapped into the set of sequential operations. In some examples, issuing 704, by the memory controller, each operation to the near-memory compute unit is carried out by the memory controller (e.g., the memory controller 106 of FIGS. 1 and 3) issuing a command for each component operation in the sequence of operation to the near-memory compute unit (e.g., the near-memory compute unit 142 of FIG. 1 or the near-memory compute unit 342 of FIG. 3).

While reading 702, by the memory controller, each operation in the set of sequential operations from the near-memory instruction store and issuing 704, by the memory controller, each operation to the near-memory compute unit have been described above as an iterative process (where each operation is read from the near-memory instruction store and scheduled for issue to the near-memory compute unit before the next operation is read), it is further contemplated that the sequential operations can be read from the near-memory instruction store in batches. For example, the memory controller reads multiple operations or even all operations of a set into a buffer or queue in the memory controller, and, after reading that batch into the memory controller, begin issuing commands for each operation in the batch. Moreover, it will be appreciated that the memory controller does not schedule any other memory request from the pending request queue for issue until all of the operations in the set of sequential operations for a complex atomic operation have been issued to the near-memory compute unit, thus preserving atomicity of the complex atomic operation.

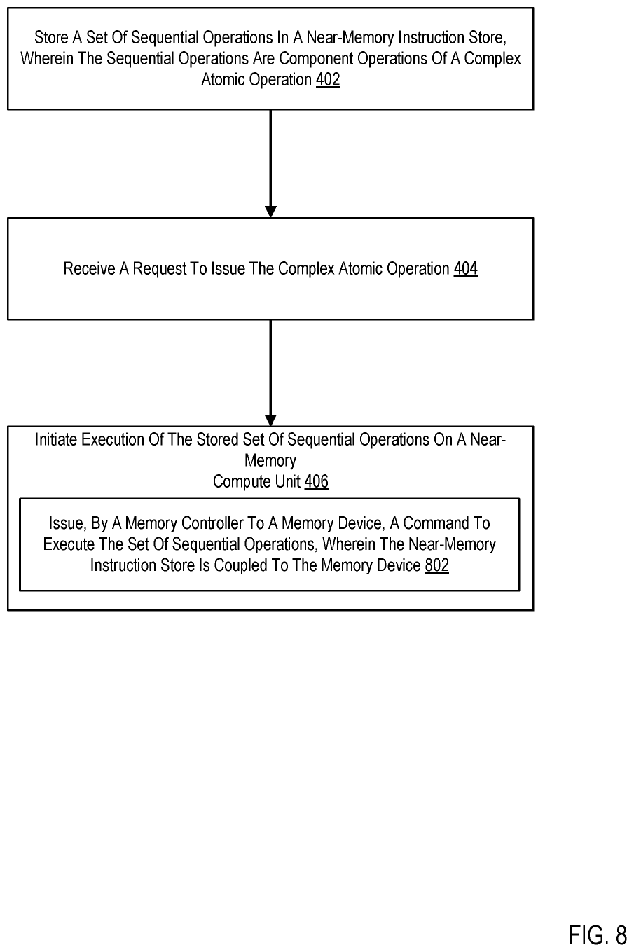

For further explanation, FIG. 8 sets forth a flow chart illustrating another example method of providing atomicity for complex operations using near-memory computing in accordance with some implementations of the present disclosure. Like the example of FIG. 4, the example method of FIG. 8 includes storing 402 a set of sequential operations in a near-memory instruction store, wherein the sequential operations are component operations of a complex atomic operation; receiving 404 a request to issue the complex atomic operation; and initiating 406 execution of the stored set of sequential operations on a near-memory compute unit.

In the example of FIG. 8, initiating 406 execution of the stored set of sequential operations on a near-memory compute unit includes issuing 802, by a memory controller, a command to a memory device to execute the set of sequential operations to the near-memory compute unit, wherein the near-memory instruction store is associated with the memory device. In the example of FIG. 8, the near-memory instruction store (e.g., the near-memory instruction store 232 of FIG. 2) is associated with the memory device (e.g., the memory device 108 of FIG. 1 and FIG. 3) in that the near-memory instruction store is implemented on the memory device side of a host-to-memory interface (e.g., the host-to-memory interface 180 of FIG. 1-3). In some examples, the near-memory compute instruction store is implemented within or coupled to the memory device, for example, as an allocated portion of DRAM, a buffer in a memory core die, a buffer in a memory logic die coupled to one or more memory core dies (e.g., where the memory device is an HBM stack), and so on. In some implementations, the near-memory compute unit is a PIM unit of the memory device. In other examples, the near-memory store is implemented as a buffer coupled to the near-memory compute unit, for example, in a memory accelerator. In these examples, such a memory accelerator is implemented on the same chip or in the same package as a memory die (i.e., the memory device) and coupled to the memory die via a direct high-speed interface.

In the example of FIG. 8, issuing 802, by a memory controller, a command to a memory device to execute the set of sequential operations to the near-memory compute unit can be carried out by the memory controller (e.g., the memory controller 106 of FIG. 2) issuing a memory command to the near-memory compute unit (e.g., the near-memory compute unit 142 of FIG. 2) or to the memory device coupled to the near-memory compute unit. In some implementations, the command provides a complex atomic operation identifier that is used by the near-memory compute unit to identify the corresponding set of sequential operations in the near-memory instruction store. This table can also indicate the duration or the number of component operations to be executed for the complex atomic operation. In some implementations, the complex atomic operation request received by the memory controller directly indicates the duration or the number of component operations to be executed for the complex atomic operation. The execution duration of the component operations is used by the memory controller in deciding when to schedule a subsequent memory operation. By waiting this duration before issuing another memory access command, atomicity is preserved for the complex atomic operation. In some examples, the command issued to the near-memory compute unit includes operand values or memory addresses targeted by the complex atomic operation. In one example, the command includes a vector or array of operands and/or memory addresses.

In some examples, the memory controller orchestrates the execution of the component operations on the near-memory compute unit through a series of triggers. For example, the memory controller issues multiple commands corresponding to the number of component operations, where each command is a trigger for the near-memory compute unit to execute the next component operation in the near-memory instruction store. In one example, the near-memory compute unit receives a command that includes a complex atomic operation identifier. The near-memory compute unit then identifies the location of the first operation of the set of sequential operations in the region of the near-memory instruction store corresponding to the complex atomic operation. In response to receiving a trigger, the near-memory compute unit increments the location in the region of the near-memory instruction store, reads the next component operation, and executes that component operation.

In view of the foregoing, readers of skill in the art will appreciate several advantages of the present disclosure. By providing user-defined and/or complex atomic computations near memory, multiple concurrent updates to memory can be performed without the overhead of explicit synchronization or the overhead of alternative software techniques. A user-definable, complex atomic operation is encoded in a single request that is sent from a compute engine to a memory controller. The memory controller can receive a single request for a complex atomic operation and generate a sequence of user-defined commands to one or more in-memory or near-memory compute unit(s) to orchestrate the complex operation, and can do so atomically (i.e., with no other intervening operations from any other requestors within the system).

Implementations can be a system, an apparatus, a method, and/or logic circuitry. Computer readable program instructions in the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some implementations, electronic circuitry including, for example, programmable logic circuitry, field-programmable gate arrays (FPGA), or programmable logic arrays (PLA) may execute the computer readable program instructions by utilizing state information of the computer readable program instructions.

Aspects of the present disclosure are described herein with reference to flowchart illustrations and/or block diagrams of methods, apparatus (systems), and logic circuitry according to some implementations of the disclosure. It will be understood that each block of the flowchart illustrations and/or block diagrams, and combinations of blocks in the flowchart illustrations and/or block diagrams, can be implemented by logic circuitry.

The logic circuitry may be implemented in a processor, other programmable data processing apparatus, or other device to cause a series of operational steps to be performed on the processor, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and logic circuitry according to various implementations of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

While the present disclosure has been particularly shown and described with reference to implementations thereof, it will be understood that various changes in form and details may be made therein without departing from the spirit and scope of the following claims. Therefore, the implementations described herein should be considered in a descriptive sense only and not for purposes of limitation. The present disclosure is defined not by the detailed description but by the appended claims, and all differences within the scope will be construed as being included in the present disclosure.

What is claimed is:

1. A method of providing atomicity for complex operations using near-memory computing comprising:
storing a set of sequential operations in a near-memory instruction store, wherein the sequential operations are component operations of a complex atomic operation;
receiving a request to issue the complex atomic operation; and
initiating execution of the stored set of sequential operations on a near-memory compute unit.

2. The method of claim 1 further comprising receiving a request to store the set of sequential operations corresponding to the complex atomic operation, wherein the complex atomic operation is a user-defined complex atomic operation.

3. The method of claim 2, wherein the request to store the set of sequential operations for the user-defined complex atomic operation is received via an application programming interface (API) call from host system software or a host application.

4. The method of claim 1, wherein storing a set of sequential operations in a near-memory instruction store, wherein the sequential operations are component operations of a complex atomic operation, includes:
storing a plurality of sets of sequential operations respectively corresponding to a plurality of complex atomic operations; and
storing a table that maps a particular complex atomic operation to a location of a corresponding set of sequential operations in the near-memory instruction store.

5. The method of claim 1, wherein initiating execution of the set of sequential operations on a near-memory compute unit includes:
reading, by a memory controller, each operation in the set of sequential operations from the near-memory instruction store, wherein the near-memory instruction store is coupled to the memory controller; and
issuing, by the memory controller, each operation to the near-memory compute unit.

6. The method of claim 1, wherein initiating execution of the stored set of sequential operations on a near-memory compute unit includes issuing, by a memory controller to a memory device, a command to execute the set of sequential operations, wherein the near-memory instruction store is coupled to the memory device.

7. The method of claim 6, wherein the memory controller orchestrates the execution of the component operations on the near-memory compute unit through a series of triggers.

8. The method of claim 1, wherein the near-memory instruction store and the near-memory compute unit are closely coupled to a memory controller that interfaces with a memory device.

9. The method of claim 1, wherein the set of sequential operations includes one or more arithmetic operations.

10. The method of claim 1, wherein a memory controller waits until all operations in the set of sequential operations have been initiated before scheduling another memory access.

11. A computing device for providing atomicity for complex operations using near-memory computing, the computing device comprising logic configured to:
store a set of sequential operations in a near-memory instruction store, wherein the sequential operations are component operations of a complex atomic operation;
receive a request to issue the complex atomic operation; and
initiate execution of the stored set of sequential operations on a near-memory compute unit.

12. The computing device of claim 11, wherein the computing device further comprising logic configured to receive a request to store the set of sequential operations corresponding to the complex atomic operation, wherein the complex atomic operation is a user-defined complex atomic operation.

13. The computing device of claim 12, wherein the request to store the set of sequential operations for the user-defined complex atomic operation is received via an application programming interface (API) call from host system software or a host application.

14. The computing device of claim 11, wherein storing a set of sequential operations in a near-memory instruction store, wherein the sequential operations are component operations of a complex atomic operation, includes:
storing a plurality of sets of sequential operations respectively corresponding to a plurality of complex atomic operations; and
storing a table that maps a particular complex atomic operation to a location of a corresponding set of sequential operations in the near-memory instruction store.

15. The computing device of claim 11, wherein initiating execution of the stored set of sequential operations on a near-memory compute unit includes:
reading, by a memory controller, each operation in the set of sequential operations from the near-memory instruction store, wherein the near-memory instruction store is coupled to the memory controller; and
issuing, by the memory controller, each operation to the near-memory compute unit.

16. The computing device of claim 11, wherein initiating execution of the stored set of sequential operations on a near-memory compute unit includes issuing, by a memory controller to a memory device, a command to execute the set of sequential operations, wherein the near-memory instruction store is coupled to the memory device.

17. The computing device of claim 11, wherein the near-memory instruction store and the near-memory compute unit are closely coupled to a memory controller that interfaces with a memory device.

18. A system for providing atomicity for complex operations using near-memory computing, the system comprising:
a memory device;
a near-memory compute unit coupled to the memory device;
a near-memory instruction store that stores a set of sequential operations, wherein the sequential operations are component operations of a complex atomic operation; and
a memory controller configured to:
receive a request to issue the complex atomic operation; and
initiate execution of the stored set of sequential operations on the near-memory compute unit.

19. The system of claim 18, wherein initiating execution of the stored set of sequential operations on the near-memory compute unit includes:
reading, by a memory controller, each operation in the set of sequential operations from the near-memory instruction store, wherein the near-memory instruction store is coupled to a memory controller; and
issuing, by the memory controller, each operation to the near-memory compute unit.

20. The system of claim 18, wherein initiating execution of the stored set of sequential operations on a near-memory compute unit includes:
issuing, by a memory controller to the memory device, a command to execute the stored set of sequential operations, wherein the near-memory instruction store is coupled to the memory device, and wherein the memory controller orchestrates the execution of the component operations on the near-memory compute unit through a series of triggers.
